(19) United States
(12) Patent Application Publication
(10) Pub. No.: US 2014/0125519 A1
(43) Pub. Date: May 8, 2014

(54) Methods for Encoding and Recovering GNSS Ephemeris For Over-The-Air Transmission

(71) Applicants: Alexander Brown, Van Couver (CA); Eric Derbez, Vancouver (CA)

(72) Inventors: Alexander Brown, Van Couver (CA); Eric Derbez, Vancouver (CA)

(21) Appl. No.: 13/884,050

(22) PCT Filed: Nov. 2, 2011
(86) PCT No.: PCT/US2011/059028

§ 371 Date: Nov. 21, 2013

Related U.S. Application Data
(60) Provisional application No. 61/411,474, filed on Nov. 9, 2010.

(51) Int. Cl. G01S 19/13; G01S 19/01

(52) U.S. Cl. CPC G01S 19/13; G01S 19/01
USPC 342/357.51; 342/352

(57) ABSTRACT

A method and apparatus for processing and transmitting precise orbit predictions of satellites in a Global Navigation Satellite System such as Navstar-GPS which employs curve fitting techniques and a polynomial and sinusoidal model to encode ephemerides, and particularly ephemerides of durations 6 hours or longer, in order to minimize bandwidth requirements over-the-air and NVRAM storage requirements. The methods also apply to GNSS constellations such as Galileo or GLONASS. Also, methods are disclosed for recovering the ephemeris on a GNSS receiver device in the constellation's native format.

### CROSS REFERENCE TO RELATED APPLICATIONS

This application claims benefit under 35 U.S.C. 119(e) of US Provisional Patent Application Ser. No. 61/411,474, filed Nov. 9, 2010 and entitled “Method For Encoding And Recovering GNSS Ephemeris For Over-the-air Transmission” and PCT Application No. PCT/US2011/059028, filed Nov. 2, 2011, entitled “Method For Encoding And Recovering GNSS Ephemeris For Over-the-air Transmission” which applications are incorporated herein by reference in their entirety.

### FIELD OF INVENTION

The present invention describes a method and apparatus for processing and transmitting precise orbit predictions of satellites in a Global Navigation Satellite System (GNSS), such as Navstar-GPS, so as to minimize over-the-air bandwidth requirements and NVRAM storage requirements. The methods in this invention also apply to GNSS constellations such as Galileo or GLONASS, COMPASS, Beidou-1, or QZSS. The method also describes how to recover the ephemeris on a GNSS receiver device in the constellation's native format.

### BACKGROUND OF INVENTION

GNSS navigation systems such as Navstar-GPS or GLONASS all require an orbit model (ephemeris) to accompany the measurements (pseudo-ranges) needed to perform a position-fix by triangulation.

These models are broadcast by the satellites and are typically valid for 4 hours (occasionally 6 hours if the control segment decides so).

A standard broadcast ephemeris (ICD200 format ephemeris) consists of the following 15 parameters for the orbit model, plus a reference time (TOE) and an ephemeris parameter set identifier (1ODE):
A—semi-major axis (the control segment actually transmits A^{1/2})
e—eccentricity
I₀—inclination
Ω₀—line of ascending nodes
ω—argument of the periapsis
M₀—mean anomaly
IDot—rate of change of inclination
ΩDot—rate of change of the line of ascending nodes
ΔN—correction to the mean motion
CIC—cos amplitude to correct the inclination
CIS—sin amplitude to correct the inclination
CUC—cos amplitude to correct argument of the latitudes
CUS—sin amplitude to correct argument of the latitudes
CRC—cos amplitude to correct radius
CRS—sin amplitude to correct radius
TOE—time of ephemeris—the reference time associated with ephemeris parameters
IODE—issue of data ephemeris—a serial number associated to each ephemeris parameter set intended to distinguish different parameter sets which occur near in time to each other

By encoding 1 to 28 or more days of precise orbit predictions (typically in SP3 format) into a format from which 4 hour ephemerides can be recovered, a GPS (or GNSS) capable device can forego decoding off-air ephemeris, thus reducing its time-to-first-fix (TTFF) and saving battery life. This also has the benefit of allowing the device to produce a fix under much more attenuated conditions, since the signal threshold for acquiring and tracking a signal is typically much lower than the threshold required for data demodulation.

Typically, consumer GPS receivers can natively handle 4 or 6 hour fits (occasionally the control segment will issue a 6 hour fit ephemeris; for simplicity 2-hour divisibility is employed for fits such that they can be used to tile a day or a few days evenly). The Galileo GNSS constellation uses the same navigation message as GPS. In contrast, GLONASS uses a method requiring numerical integration of the initial elements (position and velocity) with some force perturbations; however the Keplerian orbit can be mapped into the GLONASS native format quite easily.

Various methods for processing and transmitting orbit predictions of satellites in such systems have been disclosed in the art. For instance, U.S. Pat. No. 6,651,000 discloses “A method and apparatus for creating and distributing satellite tracking data in a compact format to a remote receiver. At least a portion of the satellite tracking data is extracted from memory and is formatted into a format prescribed by the remote receiver”.

U.S. Pat. No. 6,560,534 teaches how to track satellite data from a plurality of reference stations to generate precise orbits predictions, and fitting these to 6 hour fits using 15 parameter ICD-GPS200 format ephemeris, or alternatively shorter duration fits using 9 parameter fits as described in the aforementioned U.S. Pat. No. 6,651,000. Note that a plurality of ephemerides is sent over-the-air to receivers.

U.S. Pat. No. 7,548,200 discloses “Systems, methods and devices for improving the performance of Global Navigation Satellite System (GNSS) receivers”. In particular, the improvement of the ability to calculate a satellite position or a receiver position where a receiver has degraded ability to receive broadcast ephemeris data directly from a GNSS satellite is disclosed. Correction terms can be applied to an approximate long-term satellite position model such as the broadcast almanac.

U.S. Patent Application Publication No. 2007/0299609 presents a method in which the variations in the parameters for the ICD-GPS200 ephemeris format are modeled using either a polynomial or a physical model incorporating gravitational and atmospheric drag effects. However, it does not incorporate the use of sinusoidal terms to capture the parameters' long term behavior, nor the use of 6 hour or longer ephemeris fits in a non-overlapping contiguous sequence, nor the recording of the residual quantities needed to recover the ephemeris parameter values from their fit models precisely.

There is a continuing need to speed up the TTFF for navigation purposes and to reduce the bandwidth and storage in a system, without sacrificing accuracy. The present invention addresses these and other needs.

### SUMMARY OF INVENTION

The present invention involves a several step process whereby for each satellite in the GNSS constellation, the steps broadly involve:

(1) On a (typically stationary ground-based) server, a multi-day precise orbit prediction is fit to N ephemeris models, where N is the number of models needed to cover the whole time interval being modeled (which can be anywhere from a few hours up to 28 days or more). Each model can be of duration V (for instance V being 4, 6, 8 or more hours) with contiguous validity intervals, such that the aggregate time period covered is a single interval of length N*V. Each ephemeris model can be, for instance, the ICD-200GPS ephemeris model, but it may be restricted to a number M of ephemeris model parameters where M may be less than 15 parameters; and if needed the GNSS receiver can extend this restricted model to a full 15-parameter model by using zero for those parameters which are not included in the restricted ephemeris model. Values for the satellite clock bias, drift and drift-rate are optionally calculated by a linear or quadratic fit over the aggregate time period of the N ephemeris models.

(2) On a server, each sequence of ephemeris model parameter values (M such sequences in total), across the N ephemeris models (so that each sequence has length N), is fit to a polynomial and sinusoidal model (PSM). Having found a least-squares best PSM fit to each such sequence, the fit remainder quantities with respect to each ephemeris model parameter in each of the N ephemeris models is recorded.

(3) For each of the M ephemeris model parameters, the PSM parameter values and the N fit remainder quantities calculated in (2) are transmitted from the server to a GNSS receiver. If calculated, the clock bias, drift, and drift-rate can also be transmitted.

(4) After receiving these PSM parameter values and fit remainder quantities, a GNSS receiver can reassemble an appropriate 4, 6, 8 or more hour fit, and then, if desired adjust I₀, Ω₀, M₀, the time of ephemeris in the model, and the clock bias and drift in order to restrict its use to the appropriate 4 hour time interval suitable for use in the native format for GPS.

Particularly, a method is disclosed for encoding an orbit prediction of a satellite in a GNSS constellation over a period of time T comprising:
selecting an ephemeris model comprising at least M ephemeris model parameters;
selecting the period of time T;
dividing the period T into N subintervals;
for each subinterval I in the set of N subintervals, producing a set of M ephemeris model parameter values valid over subinterval I;
selecting a polynomial and sinusoidal model comprising polynomial and sinusoidal model parameters for modeling each of the M ephemeris model parameters;
calculating M sets of polynomial and sinusoidal model parameter values by curve fitting the polynomial and sinusoidal model to the sequence of N ephemeris model parameter values for each of the M ephemeris model parameters in the ephemeris model;
calculating N×M fit remainder quantities to the curve fitted polynomial and sinusoidal model for each of the N subintervals for each of the M ephemeris model parameters; and
recording the M sets of polynomial and sinusoidal model parameter values and the N×M fit remainder quantities.

The ephemeris model selected can be the ICD-200GPS ephemeris model and the number of ephemeris model parameter values M used can be less than or equal to 15, as is illustrated in the following Examples. The period T can be divided into N subintervals having the same duration V such that the period T has a duration N times V. V can be greater than or equal to 4 hours. In particular, when N is 28 and V is 6 hours, the time period covered is conveniently 168 hours or 1 week.

Unlike in the aforementioned prior art, the present invention uses polynomial and sinusoidal terms to model the behavior of the M parameters plus a series of small fit remainder terms at equally spaced intervals. Furthermore, the present invention can rely on ephemeris models of 6 or more hour validity and can use ephemeris models of any duration, including a programmable duration.

The set of M ephemeris model parameter values can be produced using a first Levenberg-Marquardt optimizing algorithm. The first Levenberg-Marquardt optimizing algorithm can be initialized by means of the Herrick-Gibbs algorithm in order to produce an initial position and velocity which can then be mapped to its corresponding 6 Kepler elements. A set of ephemeris model parameter values valid on a time interval (e.g. of length 4, 6, 8 or more hours), can be produced by fitting a set of predicted satellite positions given as input data, using this algorithm.

The polynomial and sinusoidal model (PSM) selected may be a least squares optimizing algorithm. A second Levenberg-Marquardt optimizing algorithm is a suitable algorithm for use in producing optimal fits to this model. Polynomial and sinusoidal model fits can be calculated by curve-fitting a sequence of ephemeris model parameter values using this algorithm.

Further, a method is disclosed for decoding an encoded orbit prediction of a satellite in a GNSS constellation which has been encoded according to the aforementioned method. The decoding method comprises:
a) obtaining the orbit prediction of the satellite which has been encoded according to the aforementioned method;
b) reading the M sets of polynomial and sinusoidal model parameter values and the N×M fit remainder quantities;
c) evaluating each of the M sinusoidal and polynomial models for each of the M sets of polynomial and sinusoidal model parameter values to produce a sequence of N values; d) adjusting each of the M sequences of length N by the respective fit remainder quantities read in step b); and
e) using the M adjusted sequences of length N from step d) as ephemeris model parameter values for the ephemeris models of each of the N subintervals.

To provide ephemeris assistance in the format native to GPS, a set of 4-hour ephemeris model parameter values can be constructed from a set of longer time duration ephemeris model parameter values. This involves selecting suitable four-hour subintervals, setting the reference times of the new 4-hour ephemerides, and setting new Io, Mo, Ω₀values.

To accomplish this in general, a clock bias, a drift and a drift rate are additionally determined and recorded as part of the encoding process. The decoding method then comprises constructing ephemeris model parameter values over the period of time T for a number of subintervals greater than N and the constructing comprises:
obtaining the recorded clock bias, the drift, and the drift rate;
setting a reference time TOE of each of the greater than N subintervals;
setting new values for I₀,M₀, and Ω₀ for each of the greater than N subintervals; and
setting new values for the clock bias and the drift for each of the greater than N subintervals in accordance with the TOE of each subinterval.

For the aforementioned situation in which ephemeris assistance is provided in the format native to GPS by constructing a set of 4-hour ephemeris model parameter values from a set of longer time duration ephemeris model parameter values, the duration of the subintervals V is 4 hours. If the number of subintervals greater than N is 42, then the period of time T is 168 hours or 1 week.

A server for encoding an orbit prediction of a satellite comprising a server which has been programmed to encode the orbit prediction according to the aforementioned method is also included in the invention.

Further still, a GNSS receiver device for recovering an orbit prediction of a satellite comprising a GNSS receiver device which has been programmed to decode the orbit prediction according to the aforementioned method is also included in the invention.

Also disclosed herein is a method of using of the relatively new clock and position information provided to a GNSS device by an off-air BCE to make adjustments to a long-term clock and orbit prediction file which improve the accuracy of the long-term prediction long after the validity period of the BCE has passed.

The method of the invention can advantageously minimize bandwidth requirements over-the-air and NVRAM storage requirements. For instance, as illustrated later, all of the PSM parameter values, fit remainder quantities, clock bias, drift and drift-rate that are required to encode 7 days for GPS purposes, can be binary encoded into a 1018-byte or smaller package.

### DESCRIPTION

Herein, the following definitions have been used.

SP3: refers to the National Geodetic Survey Standard GPS Format SP3; the standard format for encoding orbits. See: “Remondi, B. W., 1991 : NGS Second Generation ASCII and Binary Orbit Formats and Associated Interpolated Studies, Proceedings of the Twentieth General Assembly, International Union of Geodesy and Geophysics, Vienna, Austria, August 1 1-24, 1991 , 28 pp”.

Pseudo-range: a measurement from a GNSS receiver describing the receiver to satellite range with a built-in receiver bias.

ICD-200GPS ephemeris: the 15 parameter ephemeris model described in the Naystar-GPS Interface Control Document ICD-GPS-200, revision C released October 1993. It is sometimes referred to as broadcast ephemeris.

3GPP: the 3rd Generation Partnership Project, which is a collaboration between groups of telecommunications associations, to make a globally applicable third-generation 3G mobile phone system specification within the scope of the International Mobile Telecommunications-200 project of the International Telecommunication Union (ITU).

NVRAM: Non Volatile Random Access Memory (e.g. flash memory).

Radial, Along-track, and Cross-track directions: unit vectors used to decompose orbit modeling errors by projecting orbits errors onto them; their calculation is described below.

Given a position r and its associated velocity v in a reference frame (such as in WGS 84 ECI), for orbits with small eccentricity (i.e. in which the velocity vector is approximately perpendicular to the position vector), new coordinate directions are defined as:

Radial direction xᵣ [symbol] r/|r| (1)

Cross-track direction x_{c} [symbol] r×v/|r×v| (2)

Along-track direction xₐ [symbol] r×x_{c}/|r×x_{c|} (3)

That is, the radius vector to the WGS 84 origin is taken as correct; the along-track vector however will not quite align with the velocity vector (except at apogee/perigee).

Herein, the phrase “polynomial and sinusoidal model” or PSM refers to a model which involves both polynomial and sinusoidal terms.

There are standards recently adopted within the 3GPP framework to encode SP3 predictions by parametrizing them using 6 hour ICD200 format fits (that is using the parameters above and table 20-IV ICD200 rev C). The first of these predictions is then sent in whole and subsequent 6 hour fits are sent as element-wise differences from its previous prediction. That is, the 15 parameters which comprise the ICD200 format ephemeris are differenced between successive 6 hour fits. However in the 3GPP framework, the size of the differences is itself variable and needs to be transmitted. This makes the 3GPP protocol very tedious to implement.

A problem addressed by the present invention is that of parametrizing an orbit prediction—typically in SP3 format—such that it is in a compact format for over-the-air transmission, and, if desired, can be converted on the GNSS receiver into a format native to the constellation(s) the GNSS receiver uses.

The invention is particularly suitable for .application to the Global Positioning System (GPS) satellites, but is also applicable to other Global Navigation Satellite Systems (GNSS) as well as other future satellite systems where the orbits can be encoded in a 15 parameter Keplerian ephemeris. The bit budgets for certain parameters in other constellations may need to be increased—for instance in highly elliptic orbits such as the Japanese QZSS.

The following describes in a preferred embodiment how the models are generally created on a server, what information needs to be transmitted (from server to receiver), and how the models are generally recovered at a GNSS receiver device.

Model Creation (Server Side)

As per the ICD-200GPS document for GPS, an ephemeris consists of six Keplerian elements plus three rates and six sinusoidal perturbations.

The present invention can efficiently utilize curve fits over 6 hour or longer time periods, such as 8, 10, or 12 hour fits from orbit predictions in SP3 format to the ICD200 ephemeris format described above. A non-linear fit technique is used to produce each such fit; for instance, the Levenberg-Marquardt algorithm (cf. Marquardt, D. W. 1963, Journal of the Society for Industrial and Applied Mathematics, vol. 1 1, pp. 431-141.) This last method (i.e. a first use of the Levenberg-Marquardt algorithm) could be initialized using the Herrick-Gibbs algorithm (cf. Dan Boulet, Methods of Orbit Determination for the Microcomputer, Willmann-Bell, p456) to produce an initial position and velocity which can then be mapped to the 6 classical Kepler elements, but there are many other ways to proceed.

It will be appreciated that the parameters A^{1/2}, e, I₀, Ω₀, and ΔN, IDot and ΩDot and the 6 sinusoidal perturbations follow a polynomial and sinusoidal pattern. For instance see: HOTSTART EVERY TIME—Compute the Ephemeris on the Mobile: P. G. Mattos, ION Savannah Ga. 2008.

By using a second Levenberg-Marquardt algorithm each one of these ephemeris model parameters P can be modeled by a polynomial and sinusoidal model for the duration of the fit by a function P(t) and fit remainder quantities R₁, . . . ,R_{N}, of the form

P(tⱼ)=Σᵢ₌₀³Ki·(tⱼ−t₀)ⁱ+Σ^{n(P)}ᵢ₌₁{Si sin(fᵢ(tⱼt₀))+Cᵢ cos(fᵢ(tⱼ−t₀))}+Rⱼ (4)

where j is an integer between 1 and N (where N is the number of ephemeris models needed to cover the whole time interval being modeled, e.g. 7, 14, 21 , 28 days), tⱼ is the midpoint of the time interval during which the j^{th} ephemeris model is valid, t₀ is the beginning of the earliest ephemeris validity interval, and n(P) is the number of sinusoidal terms required for the PSM fit of the parameter P. K₀, . . . ,K₃ and {Sᵢ,Cᵢ,fᵢ}_{i=|}^{n(P)} are free parameters whose values are determined by the fitting algorithm. (In a preferred embodiment the highest order term in the polynomial part has degree 3.) The {fj} quantities can either be free variables to be determined by the non-linear fitting algorithm, or can optionally be made dependent quantities on the values of the parameters P.

Note that for each of the M ephemeris model parameters of the ephemeris model, the fit remainder quantity to the PSM fit at each point tⱼ is represented by the term Rj.

For example, if the total time period T is 7 days and V is 6 hours then N=28 intervals. Using a 15-parameter ephemeris model to fit each of the 28 6-hour intervals spanning a one-week period, one obtains 15 sequences of 28 ephemeris model parameter values.

Then for instance, the sequence of eccentricity values {e₁, . . . e₂₈}, can be fit by the free parameters K₀, . . . ,K₃ and {Sᵢ,Cᵢ,fᵢ}ᵢ₌₁^{n(e)} and the remainders {Rᵢ(e)} to the fits can be tabulated.

For instance, for the ephemeris model parameter e (eccentricity), Equation (4) becomes:

e(tⱼ)=Σ³ᵢ₌₀Kᵢ(e)·(tⱼ−t₀)ⁱ+Σ^{n(e)}_{i=|}{Sᵢ(e)sin(fᵢ(e) (tⱼ−t₀))+Cᵢ(e) cos(fᵢ(e) (tⱼ−t₀))}+Rⱼ(e)

Some parameters, such as the rates ΔN, IDot and ΩDot, are very sensitive and therefore need much more precision (and therefore bits to encode) for the corresponding remainder terms Rⱼ than the remainder terms for parameters like CRC & CRS or CIS & CIC, for instance.

Values for the clock bias, drift and drift-rate {a_{fo}, a_{f1}, a_{f2}} can optionally be calculated in order to provide ephemeris assistance on reassembly in the format native to GPS of shorter 4-hour subinterval duration. Such values for the clock bias, drift and drift-rate {a_{fo}, a_{f1}, a_{f2}} can be calculated by a linear fit of the input clock data over the aggregate time period of the N ephemeris models.

Information Transmitted

The following data are transmitted over-the-air from the server to the GNSS receiver:
one clock bias a_{f0}, one clock drift a_{f1} and one drift-rate a_{f2};
the length V of the ephemeris model used (e.g. 4, 6, 8, or other hours);
the PSM parameter values K₀, . . . ,K₃, S₀, C₀, f₀, . . . , Sₙ, Cₙ, fₙ, where n depends on each parameter, for each of the 15 ephemeris model parameters A, e, I₀, Ω₀, ω, M₀, ΔN, ΩDot, IDot, CRC, CRS, CIC, CIS, CUC, CUS (or fewer if a restricted ephemeris model is used); and
the fit remainder quantities {Rⱼ}ⱼ=i^{N} to the PSM fit.

Model Recovery (GNSS Receiver Side)

To use the data on the GNSS receiver side, the user can simply apply the models in Equation (4) to recover the 15 parameter ephemerides fitting a V hour span of 4 or more hours.

Natively for GPS navigation, a 15 parameter Keplerian ephemeris should be set to be valid for 4 hours. If desired then, an ephemeris model, created and recovered as above but which spans a longer time period, can be adjusted for use on a GNSS receiver device in the 4 hour native format of GPS. A method for accomplishing this is exemplified below.

For native GPS format, a series of models of 4 hour validity is determined from the longer ephemeris model. The series, in combination, is equivalent to the original, longer time span ephemeris model.

Generally, for each model in the series, at a particular time t bracketed by an ephemeris valid on a time interval I of length V, a new time of ephemeris, TOE_{new} is chosen within 2 hours from t such that TOE_{new} is within the interval I and at least 2 hours away from either end-point of interval I. In calculating a satellite position from a set of ephemeris parameters, the dependence on the TOE involved is entirely captured in the three parameters I₀, Ω₀ and M₀. Thus, after appropriately adjusting the TOE and these three variables, the satellite position calculated from the new data will be the same as the one produced from the original (longer time) ephemeris data.

The 3 parameters are adjusted according to the time difference between the original fit reference time, TOE₀|_{d}, and the desired time of ephemeris TOE_{new} via:

I_{0(new)}=IDot*ΔT+I₀, (where ΔT=TOE_{new}−TOE_{old}) (5)

M_{0(new)}=((μₑₐᵣₜₕ/A³)^{1/2} +ΔN)*ΔT+M₀, (6)

(where μₑₐᵣₜₕ is Earth's gravitational constant)

Ω_{0(new)}=ΩDOT*ΔT+Ω₀ (7)

The clock bias and drift are adjusted as follows:

a_{f0(new)}=a_{f0}+a_{f1}*ΔT_{c}+a_{f2}*(66 T)²

a_{f1(new)}=a_{f1}+2*a_{f2}*ΔT_{c}

where ΔT_{c} is the time difference between the clock fit time (typically the midpoint of the aggregate time period of the N ephemeris models) and TOE_{new}.

Thus, apart from the new values of I₀, Ω₀, M₀, and new TOE, the new model is equivalent to the parent model (i.e. the model with the old values of I₀, Ω₀ and M₀), in that it describes the same arc during its 4 hours of validity. That is, after adjusting the TOE and these three variables, the satellite position calculated from the new data will be the same as the one produced from the original (longer time) ephemeris data.

Exemplary Data Flow and Computations Summary

The following sections, labeled Server. Over the Air, and GNSS Receiver, summarize the flow of operations in a complete exemplary application of the invention over several durations of ephemerides (4, 6, and 8, or other, hours):

Server

1. Ingest SP3 predictions and map to N ephemerides of V hour duration (V>=4); calculate clock bias, drift and drift-rate:

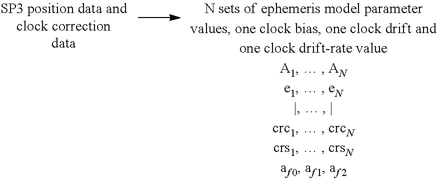

2. For each of the 15 ephemeris model parameters across the N ephemerides, fit the PSM parameters in Equation (4) using a least squares optimizing algorithm and compute the N fit remainder quantities R|, . . . ,R_{N}:

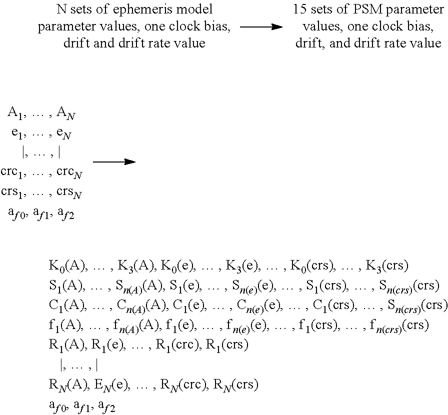

such that:

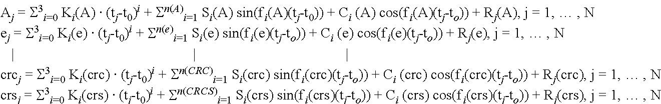

Over the Air

For each satellite, transmit from the server to the GNSS receiver:
the length of the prediction;
the clock bias, drift and drift-rate {aᵣₒ, a_{f1}, aₐ}; and
15 sets of {(K₀, . . . ,K₃, S₁, C₁, f₁. . . , Sₙ, Cₙ, fₙ) and the remainders (Rⱼ)ⱼ₌₁^{N}.}

Note n depends on the parameter in question. Also note that it is desirable to add an element of randomness to the timing of the request for the next batch of predicted ephemeris data so as not to burden the servers with simultaneous requests.

GNSS Receiver

Re-assemble N ephemeris fits into the 15 parameter ICD-200GPS ephemerides using Equation (4). For a given use time t, find the appropriate model bracketing t, round t to the nearest 2 hours to become the TOE, while staying clear of the model fit end-points. With this new time of ephemeris, adjust I₀, Mo, Ω₀, a_{f0} and a_{f1} as in Equations (5), (6), (7), (8), and (9) for that model, construct and assign a unique IODE number to the new 4-hour ephemeris, and inject into the position engine software.

For 6, 8, or other hour durations then, the original ephemeris can be re-assembled into a series of overlapping or non-overlapping ephemeris models of 4 hour duration each respectively as illustrated below:

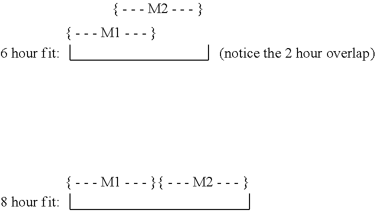

M1 and M2 are the 4 hour models which together capture the behavior of the 6 or 8 hour fits. Similar scenarios could be envisaged for a 5, 8, 10 hour, or longer fit.

While the preceding discussion was directed to the Naystar-GPS constellation, those skilled in the art will appreciate that the present methods can also be applied in other systems as well. For instance in the GLONASS ephemeris model the initial elements (position and velocity) must fall on a 15 minute boundary (Moscow local time) and the GLONASS model is only usable +/−15 minutes on either side of the TOE, For a GLONASS receiver to recover the ephemeris data in its native format, the elements for a GLONASS ephemeris may be created by term-by-term differentiation of the (1CD200GPS) ephemeris model to recover position and velocity. The luni-solar accelerations terms may be set to zero without significantly degrading the accuracy of the model. As mentioned before, the bit budget may have to be modified for highly elliptic orbits such as the QZSS (Quasi-Zenith system planned by Japan).

Orbit and Clock Updates from BCE

In order to correct these errors, a GNSS receiver can benefit from using off-air ephemeris updates (or 4-hr real-time ephemeris updates from a server) not only to adjust clock bias and drift, but also to adjust ephemeris prediction errors by computing the radial, along and cross-track error vector between the off-air (broadcast) ephemeris (BCE) at the end of its validity T_{end} and the predicted ephemeris. Subtracting this radial, along, and cross-track offset can reduce the user range error compared to that of the prediction. One can then adjust all the ephemerides in the present and future of this BCE by subtracting this radial, along and cross-track vector and converting this to local ECEF error vectors. For a given 4 hour ephemeris, these ECEF error vectors (for instance 17 of them) can then be mapped to the 15 (or M) parameters of the future ephemeris models, by an extra iteration of the Newton-Raphson (or Levenberg-Marquardt) non-linear routine. The clock and drift are updated too.

It should be appreciated the method of performing orbit and clock updates from BCE is independent of the PSM model that was used to encode and transmit the prediction data, as the updates take effect after the decoding has been done on the GNSS device, and before the ephemeris assistance is supplied to the GNSS device positioning engine. Thus, any suitable method of performing orbit and clock updates from BCE may be employed.

### EXAMPLE 1

### Very Low Bandwidth Requirements

This example is a predicted example and illustrates an embodiment of the invention which results in an extremely small size prediction data download package. The bandwidth savings in this particular example can be sketched as follows:

A conventional ICD-200GPS 4-hour ephemeris takes around 45 bytes to encode. Thus it would take 28*6*45(bytes/ephemeris)˜7560 Bytes (it takes 6 ephemerides to tile one day) to encode 28 days.

However, with 8-hour ephemeris models encoded according to the techniques described herein, using around 50 bytes to encode the model and about 15 bytes to encode the necessary terms for each 8 hour fit, it would take about
50+(28*3*15 bytes/correction terms)−1310 Bytes (it takes only three 8-hour fits to tile one day).

Clock bias and drift values can be sent in sec and sec/sec with scale factors of 2⁻³¹ and 2⁻⁴⁵ respectively encoded as a signed 22 and 18 bit integers (for a total of 5 bytes) when encoding a 28 day prediction. For 7 day predictions the drift can be adequately encoded with a signed 16 bit integer with scale factor 2″⁴³. These scale factors can accommodate GPS, Glonass, and Galileo.

For a GNSS constellation such as GPS with 32 satellites, this procedure could encode 28 days of prediction data in only (1310+5)*32=42080 bytes.

As is evident from this example, there can be a substantial reduction in bandwidth requirements using the technique of the invention.

### EXAMPLE 2

### High Precision and Low Bandwidth Requirements

This example was actually implemented on a computer and illustrates an embodiment of the invention which produces a high precision result and nevertheless releases substantial bandwidth savings. The bandwidth requirements in this particular example can be sketched as follows:

A conventional ICD-200GPS 4-hour ephemeris takes around 45 bytes to encode. Thus it would take 7*6*45(bytes/ephemeris)−1890 Bytes (it takes 6 ephemerides to tile one day) to encode 7 days of prediction data.

However, with 6-hour ephemeris models encoded according to the techniques described herein, it is possible to encode 7 days of prediction data (including clock data) in less than one kilobyte (1024 bytes):

For this example the period of time T is 7 days, N=28 intervals, V=6 hours, and M=15 parameters.

Using around 15 bytes to express the parameters of each PSM model and about 28 bytes to express the remainder quantities for each 6 hour fit, it would take about
15* 15+(7*4*28 bytes/remainder terms)˜1009 bytes (it takes only four 6-hour fits to tile one day).

Clock bias, drift and drift-rate values are sent in units of sec, sec/sec, and sec/sec² respectively, with scale factors of 2⁻⁴⁰, 2⁻⁵⁰ and 2⁻⁶⁴ respectively, encoded as a signed 32-, 24-, and 16-bit integers respectively (for a total of 9 bytes) when encoding a 7 day prediction. Thus, a total of about 1009+9=1018 bytes is required to be transmitted in all. These scale factors can accommodate GPS, GLONASS, and Galileo.

For a GNSS constellation such as GPS with 32 satellites, this procedure could encode 7 days of prediction data in only (1009+9)*32=32576 bytes.

In this actual implementation, the ephemeris received on the client was within 3.5 meters of the original predicted position 99% of the time, 2.1 meters of the original predicted position 95% of the time, and 1 meter of the original predicted position 65% of the time.

This example also demonstrates a substantial reduction in bandwidth requirements using the technique of the invention.

All of the above U.S. patents and applications, foreign patents and applications and non-patent publications referred to in this specification, are incorporated herein by reference in their entirety.

While particular embodiments, aspects, and applications of the present invention have been shown and described, it is understood by those skilled in the art, that the invention is not limited thereto. Many modifications or alterations may be made by those skilled in the art without departing from the spirit and scope of the present disclosure.

What is claimed is:

1. A method for encoding an orbit prediction of a satellite in a GNSS constellation over a period of time T comprising:
selecting an ephemeris model comprising at least M ephemeris model parameters;
selecting the period of time T;
dividing the period T into N subintervals;
for each subinterval I in the set of N subintervals, producing a set of M ephemeris model parameter values valid over subinterval I;
selecting a polynomial and sinusoidal model comprising polynomial and sinusoidal model parameters for modeling each of the M ephemeris model parameters;
calculating M sets of polynomial and sinusoidal model parameter values by curve fitting the polynomial and sinusoidal model to the sequence of N ephemeris model parameter values for each of the M ephemeris model parameters in the ephemeris model; calculating N×M fit remainder quantities to the curve fitted polynomial and sinusoidal model for each of the N subintervals for each of the M ephemeris model parameters; and recording the M sets of polynomial and sinusoidal model parameter values and the N×M fit remainder quantities.

2. The method of claim 1 comprising selecting the ICD-200GPS ephemeris model as the ephemeris model.

3. The method of claim 1 wherein the period T is divided into N subintervals of duration V such that the period T has a duration N times V.

4. The method of claim 3 wherein N is 28.

5. The method of claim 4 wherein V is greater than or equal to 4 hours.

6. The method of claim 5 wherein V is 6 hours.

7. The method of claim 2 wherein the number of ephemeris model parameter values M is less than or equal to 15.

8. The method of claim 1 comprising producing the set of M ephemeris model parameter values using a first Levenberg-Marquardt optimizing algorithm.

9. The method of claim 8 comprising initializing the first Levenberg-Marquardt optimizing algorithm using a Herrick-Gibbs algorithm.

10. The method of claim 1 comprising selecting a least squares optimizing algorithm for the polynomial and sinusoidal model.

11. The method of claim 10 comprising selecting a second Levenberg-Marquardt optimizing algorithm for the polynomial and sinusoidal model.

12. The method of claim 1 additionally comprising:
determining a clock bias, a drift and a drift rate; and
recording the clock bias, the drift, and the drift rate.

13. The method of claim 12 comprising recording the M sets of polynomial and sinusoidal model parameter values, the N×M fit remainder quantities, the clock bias, the drift, and the drift rate into a file of size less than or equal to 1018 bytes per week of orbit prediction.

14. A method for decoding an encoded orbit prediction of a satellite in a GNSS constellation comprising:
a) obtaining the orbit prediction of the satellite encoded according to the method of claim i;
b) reading the M sets of polynomial and sinusoidal model parameter values and the N×M fit remainder quantities;
c) evaluating each of the M sinusoidal and polynomial models for each of the M sets of polynomial and sinusoidal model parameter values to produce a sequence of N values; d) adjusting each of the M sequences of length N by the respective fit remainder quantities read in step b); and
e) using the M adjusted sequences of length N from step d) as ephemeris model parameter values for the ephemeris models of each of the N subintervals.

15. The method of claim 14 wherein the ephemeris model selected is the ICD-200GPS ephemeris model.

16. The method of claim 15 wherein the encoded orbit prediction comprises a recorded clock bias, drift, and drift rate, the method comprising constructing ephemeris model parameter values over the period of time T for a number of subintervals greater than N and the constructing comprises:
obtaining the recorded clock bias, the drift, and the drift rate;
setting a reference time TOE of each of the greater than N subintervals;
setting new values for I₀,M₀, and Ω₀ for each of the greater than N subintervals; and setting new values for the clock bias and the drift for each of the greater than N subintervals in accordance with the TOE of each subinterval.

17. The method of claim 16 wherein the number of subintervals greater than N is 42.

18. The method of claim 17 wherein the period of time T is 168 hours.

19. A server for encoding an orbit prediction of a satellite comprising a server which has been programmed to encode the orbit prediction according to the method of claim 1.

20. A GNSS receiver device for decoding an orbit prediction of a satellite comprising a GNSS receiver device which has been programmed to decode the orbit prediction according to the method of claim 14.
